(19) United States
(12) Patent Application Publication
(10) Pub. No.: US 2009/0182886 A1
(43) Pub. Date: Jul. 16, 2009

(54) DELIVERY AND DISPLAY OF INFORMATION OVER A DIGITAL BROADCAST NETWORK

(75) Inventors: Jonathan Paul McCartie, Los Angeles, CA (US); George Allen Rothrock, San Diego, CA (US); Nicholas Andrew Glassman, Venice, CA (US); Michael K. Bailey, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/015,002

(22) Filed: Jan. 16, 2008

(51) Int. Cl. G06F 15/16

(52) U.S. Cl. 709/230

(57) ABSTRACT

A digital broadcast network is disclosed that can provide information at different frequency repetition rates in order to mitigate delay of information at a receiving device. A data stream can be divided into sets of data and depending on how each set of data will be consumed by a user, respective weights or priorities can be assigned to each set. Based on the weight or priority, at least one set of data can repeat more frequently within the data stream than other sets of data. Thus, upon receiving the data stream, the set of data repeated more frequently can be rendered on a user device at substantially the same time as the information is requested. Assigning a more frequent repetition rate of certain sets of data allows the receiving device to quickly obtain and render more important data.

### BACKGROUND

1. Field

The following description relates generally to content distribution systems and more particularly to content delivery and content receipt over a digital broadcast network.

2. Background

A digital broadcast network is a one-way delivery method to client-side software located on a user device. Datacast services provide data over a digital broadcast network to be used by the client-side software. The data is used to provide a user-experience through the client software associated with the datacast service. The delivery method of the data is similar to that used by traditional linear services such as video and audio signals. Subsequently, all information is provided in a “first to last” stream that materially influences the responsiveness of the user-experience.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

The restrictions on data throughput inherent in the datacast services broadcast system limits the delivery and display of data to and by the client software associated with the datacast service. The richer the data needed for the user experience, the more difficult it becomes to parse and provide that data in a manner that supports the intended user experience. When the client is activated and begins receiving data over the digital broadcast, it begins to accumulate the data available at that time.

Due to the nature of broadcast, there is no way to ensure that the data available at “tune in” is the most advantageous to the user experience. For example, if the broadcast network were to broadcast the twenty-six letters of the alphabet, A-Z, and the user launches the application while “B” is being broadcast, the user must wait for the other twenty-four letters to be broadcast before it receives “A.” This limitation creates significant user-experience issues with streams that include extensive amounts of time-sensitive data.

In accordance with one or more embodiments and corresponding disclosure thereof, various aspects are described in connection with deconstructing and reordering data for intelligent delivery to a client and logic and/or algorithms that drive it. Also provided is client functionality that interprets the data from the stream and intelligently manages the data in order to provide a better user experience.

An aspect relates to a method for transmitting content. The method includes transmitting information such that a first set of data is repeated more frequently than at least a second set of data within the transmission. The frequency of repetition is a function of the characteristics of a client side application that is rendering the data.

Another aspect relates to a device for transmitting content. The device includes a computer platform having a memory and a processor wherein the memory stores information related to decisions made by the processor. Also included in the device is an evaluator that analyzes information within a data stream and a prioritizer that reviews a client application and determines when data sets within the data stream will be consumed by the client application. A transmitter that selectively transmits the data sets at different repetition rates within the data stream with reference to when the data sets will be consumed by the client application is also included in the device.

In a related aspect is an apparatus for selectively transmitting a first data set more frequently than at least a second data set. The apparatus includes a means for transmitting information such that a first data set is repeated more frequently than at least a second data set within the transmission. The frequency repetition is a function of the characteristics of a client side application rendering the data set on a user device.

Yet another aspect relates to a machine-readable medium having stored thereon machine-executable instructions for transmitting information. Additionally, the instructions are for reviewing a client application, dividing the client application data that is consumed by the client application into a first set of data and at least a second set of data, and assigning a weight to each set of data based on when each set of data will be consumed by the client application. The client application is transmitted such that a first set of data is repeated more frequently than at least a second set of data with the transmission, wherein the frequency repetition is a function of the characteristics of a client side rendering device.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system that enables selective delivery and selective receipt of content on one or more wireless devices.

FIG. 2 illustrates a schematic diagram of an aspect of the content of FIG. 1.

FIG. 3 illustrates a wireless device in accordance with the disclosed aspects.

FIG. 4 illustrates a block diagram of an example system for providing content over a digital broadcast network.

FIG. 5 illustrates an example system that utilizes artificial intelligence to automate one or more aspects.

FIG. 6 illustrates a system that delivers an experience of timely data of a category and type of particular interest to a user.

FIG. 7 illustrates a method for providing content.

FIG. 8 illustrates a method for transmitting a multitude of channels as a function of a client-side rendering experience.

FIG. 9 illustrates a method for selectively accepting one or more channels as a function of characteristics of a rendering device.

FIG. 10 illustrates an example system for selectively transmitting a first data set more frequently than at least a second data set.

### DETAILED DESCRIPTION

Various embodiments are now described with reference to the drawings. In the following description, for purposes of explanation, numerous specific details are set forth in order to provide a thorough understanding of one or more aspects. It may be evident, however, that such aspects(s) may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a wireless terminal. A wireless terminal can also be called a system, subscriber unit, subscriber station, mobile station, mobile, mobile device, remote station, remote terminal, access terminal, user terminal, terminal, wireless communication device, user agent, user device, or user equipment (UE). A wireless terminal may be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station may be utilized for communicating with wireless terminal(s) and may also be referred to as an access point, Node B, or some other terminology.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

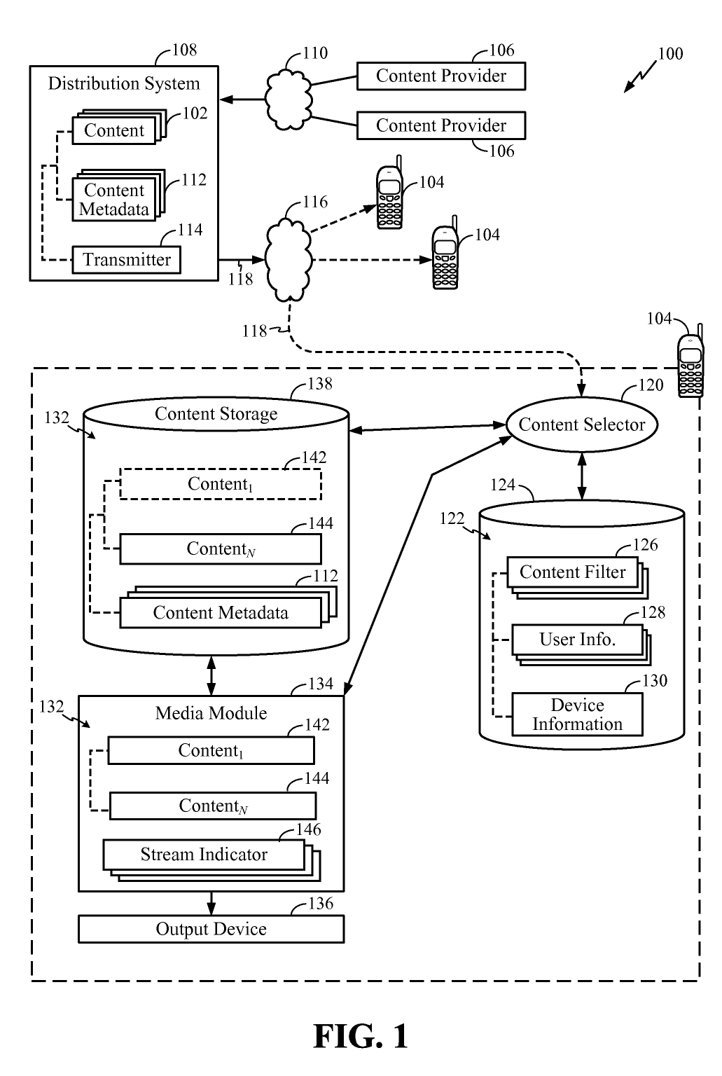

Referring to FIG. 1, illustrated is a system 100 that enables selective delivery and selective presentation of content 102 on one or more wireless devices 104. System 100 may include one or more content providers 106 operable to provide one more pieces of content 102 to distribution system 108, such as through a first network 110. Distribution system 108 is operable to deliver one or more sets of content 102, along with one or more content metadata 112 associated with each set of content 102, to the one or more wireless devices 104. For example, distribution system 108 may include a transmitter 114 and/or a second network 116, wherein transmitter 114 is operable to generate a one-to-many transmission 118 of content 102 and/or content metadata 112 for delivery to one or more wireless devices 104 through second network 116.

The one or more sets of content (or data) 102 can be transmitted based on a weight or priority that is a function of the characteristics of a client side rendering application. The weight or priority can be utilized to determine at least a first set of data that should be repeated at a different frequency than other sets of data.

For example, a first set of data might relate to current weather conditions and a second set of data might relate to a five-day weather forecast. The weight or priority might indicate that the first set of data (e.g., the current conditions) should be repeated twice as often as the second set of data (e.g., five-day weather forecast). The weight or priority might be based on the fact that the information is more informative to the user, the information might be of more interest to the user, or based on other factors (e.g., first screen principle). In this example, the first set of data is assigned a weight that is double the weight assigned to a second set of data. Thus, the first set of data will be repeated at a frequency that is double that of the second set of data. This can provide the user with more desirable information (e.g., current conditions) without waiting for the application to receive other associated data (e.g. the entire ten-day forecast). It should be understood that a variety of means can be utilized to establish the weight or priority as well as that the weight is not limited to a numerical value.

Upon accessing transmission 118, each wireless device 104 is operable to execute a content selector 120, which can be configured to determine selected content 102 in transmission 118 to download to wireless device 104 based on one or more selection parameters 122 within a selection database 124. Selection parameters 122 may include, but are not limited to, data such as one or more content filters 126 (e.g. relevant information contained in a stream or on a handset, priority data), one or more data representing user information 128 (e.g., preferences), and/or one or more data representing device information 130 (e.g. capabilities, limitations, display size, audio functionality). Selection parameters 122 can be unique to, and/or customized for, each respective wireless device 104 and/or each respective user of each wireless device 104. As such, in some aspects, each wireless device 104 may download or filter for a different set of content 102 within the same transmission 118. Thus, in some aspects, one or more selection parameters 122 allow content selector 120 to download one or more selected content 132 of interest to a respective user of the respective wireless device 104 based on a match between one or more of the respective content metadata 112 and one or more of the selection parameters 122.

Further, for example, in aspects where selected content 132 comprises a real time or live content, content selector 120 may forward selected content 132 to a media module 134 for presentation through an output device 136. In other aspects, for example, where selected content 132 comprises a non-real-time content, content selector 120 may forward selected content 132 to be cached or saved in a content storage 138. In the non-real-time case, media module 134 is operable to access content storage 138 at any time to retrieve and cause a presentation through output device 136 of the selected content 132.

Output device 136, in combination with media module 134, is operable to generate selected content 132 as a program or presentation for consumption by a user of wireless device 104. Each program or presentation may comprise a combination of one or more pieces of selected content 132 (labeled Content₁ 142 through Content_{N} 144) drawn from a broadcast stream, storage, or other network. Some of this data may reside on the handset. The selected content 142, 144 can be associated with one more of the content metadata 112 corresponding to each selected content 142, 144.

A “first screen” principle as used herein is based on the assumption that the first screen or first information that the user perceives (e.g., visually, audibly, and so forth) likely contains the most important data. If this screen is not populated with relevant data in a timely manner, the user might lose interest, discontinue use of the application, or have a negative experience due to high latency. Therefore, the data that is used to generate this “first screen” should be prioritized over other data that is not used in providing this screen. This “secondary” data is transmitted at less frequent intervals than the primary data. By broadcasting the primary “first screen” data more frequently, system 100 can provide a better experience than a strictly linear data broadcast method (e.g., first-to-last). Thus, system 100 can manage and present data in a more relevant and efficient manner. This can allow the user of the datacast service to have a better experience by enjoying timely, intuitive and entertaining interaction with the various applications.

In accordance with a related aspect, the content 102 can be delivered as individual streams of data, wherein a complete content set can include multiple streams of data (e.g., a single application is divided into multiple streams). The content 102 and/or content metadata 112 can be divided or portioned into multiple streams or multiple channels based on a priority level associated with portions of the content. One or more of the channels can be selectively received based on the content (e.g., priority) included in each stream and combined (if more than one is selected) for presentation at a respective wireless device 104. The one or more selected content 142, 144 of a respective program or presentation may include one or more associated stream indicators 146, each of which define a corresponding stream of content. Thus, each content 142, 144 can provide a reference or association to a corresponding stream (e.g., a first subset of data identifies its corresponding second or more subsets of data). Providing reference information for corresponding subsets of data allows content selector 120 to choose pieces of selected content that are in an appropriate order (e.g., first screen) and which can enrich the user experience.

In accordance with some aspects, first network 110 and second network 116 provide respective communication links between the various components and/or entities of system 100. In some aspects, first network 110 and second network 116 may comprise independent networks, while in other aspects they may comprise inter-related networks. Generally, first network 110 and second network 116 each may comprise any one or any combination of one or more data networks and/or one or more communications networks. For example, in some aspects, first network 110 may comprise a public communications network, such as the Internet, and second network 116 may comprise a subscription based one-to-many network, such as a multicast network such as a Forward Link Only (FLO) network, including the MediaFLO™ System available from QUALCOMM, Incorporated of San Diego, Calif. In other aspects, first network 110 and second network 116 may include one or a combination of other networks, such as: a digital video broadcasting (DVB) network, such as DVB-S for satellite, DVB-C for cable, DVB-T for terrestrial television, DVB-H for terrestrial television for handhelds; a terrestrial telephone network; a satellite telephone network; an infrared network such as an Infrared Data Association (IrDA)-based network; a short-range wireless network; a Bluetooth® technology network; a ZigBee® protocol network; an ultra wide band (UWB) protocol network; a home radio frequency (HomeRF) network; a shared wireless access protocol (SWAP) network; a wideband network, such as a wireless Ethernet compatibility alliance (WECA) network, a wireless fidelity alliance (Wi-Fi Alliance) network, and a 802.11 network; a public switched telephone network; a public heterogeneous communications network, such as the Internet; a private communications network; and land mobile radio network.

Further, examples of telephone networks that may be included in some aspects of first network 110 and/or second network 116 include one, or any combination, of analog and digital networks/technologies, such as: code division multiple access (CDMA), wideband code division multiple access (WCDMA), universal mobile telecommunications system (UMTS), advanced mobile phone service (AMPS), time division multiple access (TDMA), frequency division multiple access (FDMA), orthogonal frequency division multiple access (OFDMA), global system for mobile communications (GSM), single carrier (1X) radio transmission technology (RTT), evolution data only (EV-DO) technology, general packet radio service (GPRS), enhanced data GSM environment (EDGE), high speed downlink data packet access (HSPDA), analog and digital satellite systems, and any other technologies/protocols that may be used in at least one of a wireless communications network and a data communications network.

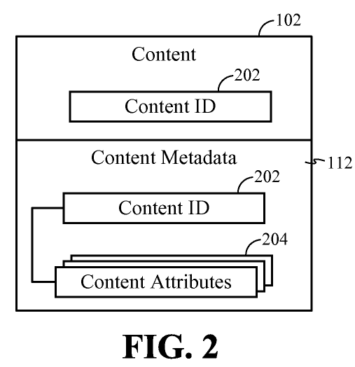

Referring to FIG. 2, illustrated is a schematic diagram of an aspect of the content of FIG. 1. Content 102 as used herein may comprise, but is not limited to, at least one of video, audio, multimedia content, real-time content, non-real-time content also referred to as “clips,” scripts, programs, or any other type of data or object operable to be distributed to and executed or presented by wireless device 104. For example, content 102 may include one or any combination of subscribed to programming, ad hoc and/or on-demand received programming, and/or advertising or any other form of content added to, inserted within and/or presented simultaneously with or in place of other content. Additionally, for example, content 102 may comprise, but is not limited to, a television show, a video, a movie, a song, interactive data such as World Wide Web pages and links, etc. Further, content 102 may comprise a unique content identifier (ID) 202, such as one or any combination of a letter, a number, a name, a file name, a file path, etc. associated with the respective piece of content.

Additionally, at least one of the multitude of content 102 is associated with one or more content metadata 112. For instance, one or more of the “content suppliers” may define the respective content metadata 112, and associate the content metadata 112 with the respective content. As used herein, the term “content supplier” may include one or any combination of a content provider such as content provider 106, a content retailer, a billing and customer service provider, and a media distributor such as distribution system 108. Content metadata 112 comprises any data that describes and/or is associated with each respective piece of content 102. For example, content metadata 112 may comprise, but is not limited to, one or any combination of content ID 202 and one or more content attributes 204, such as a category, a name, a content length, a content type, associated stream indicator 146, a code, an identifier, a theme, a genre, an intended audience and/or market, a script, a content filter identifier, a cuing protocol parameter, a related audience and/or market, and/or any metadata relating to the corresponding content. One or more content metadata 112 may be separate from, attached to or embedded within the respective content 102. In some aspects, for example, when content 102 and content metadata 112 are separate, they each may comprise or point to the same content ID 202, for example, to enable the respective content metadata to be related to the respective piece of content.

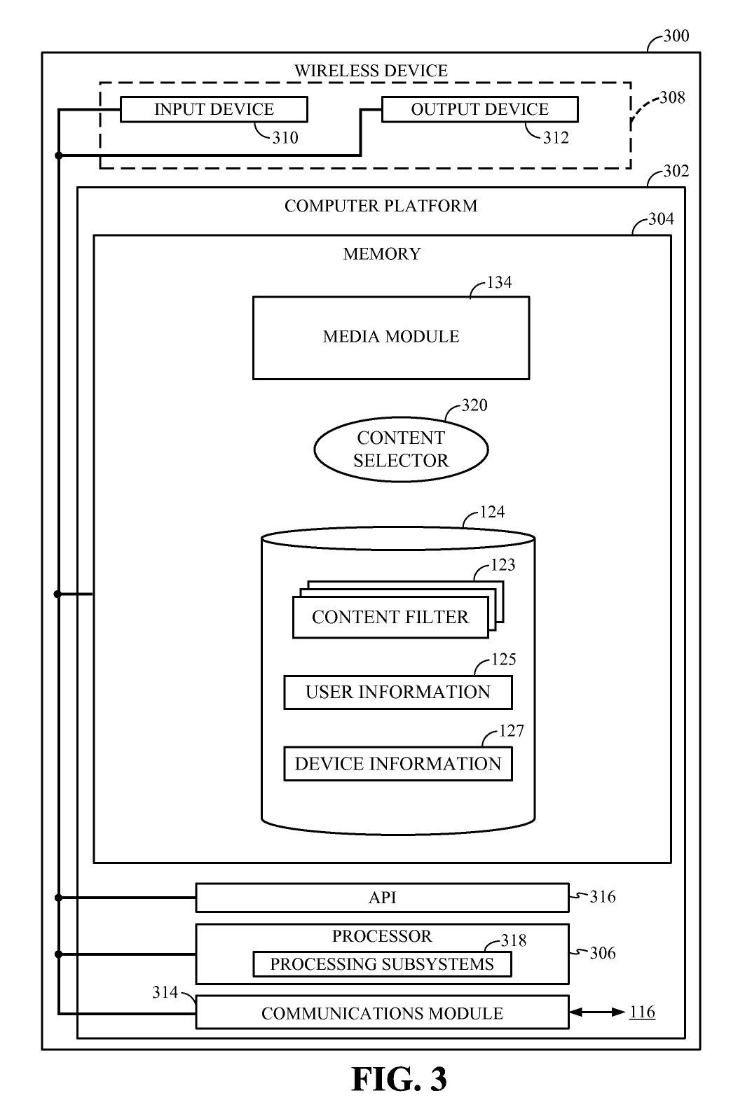

FIG. 3 illustrates a wireless device 300 in accordance with the disclosed aspects. Wireless device 300 represents wireless device 104 of system 100 (FIG. 1) and is operable to access second network 116 in order to receive transmission 118 and/or to communicate with distribution system 108. Each wireless device 300 may comprise a computer platform 302 having a memory 304 operable to store data, logic and applications executable by a processor 306. A user may interact with wireless device 300 and its resident applications through one or more user interfaces 308, which may include one or more input devices 310 and one or more output devices 312. Additionally, wireless device 300 may exchange communications with external devices and/or networks through a communications module 314.

It should be noted that although wireless devices 300 may be illustrated as cellular telephones, any number and combination of types of wireless devices 300 may be included in system 100 of FIG. 1. For example, wireless device 300 may include, but is not limited to, a cellular telephone, a Personal Digital Assistant (PDA) a laptop computer, a two-way pager, a portable gaming device, a portable music device, or any type of computerized, wireless device. The disclosed aspects can accordingly be performed on any form of wireless device or computer module, including a wired or wireless communication portal, including without limitation, wireless modems, PCMCIA cards, access terminals, personal computers, telephones, or any combination or sub-combination thereof.

Computer platform 302 is operable to transmit data across a network, such as first network 110 (FIG. 1) and/or second network 116 (FIG. 1), and is operable to receive and execute routines and applications and optionally display data generated within wireless device 300 or received from any network device or other computer device connected to the network or connected to wireless device 300. Computer platform 302 may be embodied in, for example, one or any combination of hardware, firmware, software, data and executable instructions.

Memory 304 may comprise one or any combination of volatile and nonvolatile memory, such as read-only and/or random-access memory (RAM and ROM), EPROM, EEPROM, flash cards, flash memory cells, an electronic file system, and any memory common to computer platforms. Further, memory 304 may include one or more of any secondary or tertiary storage device, such as magnetic media, optical media, tape, or soft or hard disk, including removable memory mechanisms.

Further, processor 302 may be one or more of an application-specific integrated circuit (“ASIC”), a chipset, a processor, a logic circuit, and any other data processing device. In some aspects, processor 304, or other processor such as an ASIC, may execute an application programming interface (API) layer 316 that interfaces with any resident programs stored in memory 304 of wireless device 300. API 516 is typically a runtime environment executing on the respective wireless device. One such runtime environment is Binary Runtime Environment for Wireless® (BREW®) software developed by QUALCOMM, Incorporated of San Diego, Calif. Other runtime environments may be utilized that, for example, operate to control the execution of applications on wireless computing devices.

Additionally, processor 302 may include various processing subsystems 318 embodied in hardware, firmware, software, data, executable instructions and combinations thereof, which enable the functionality of wireless device 300 and the operability of wireless device on network 116 of FIG. 1. For example, processing subsystems 318 allow for initiating and maintaining communications, and exchanging data, with distribution system 108 and/or other networked devices. In aspects in which the wireless device 300 is defined as a cellular telephone, for example, processor 306 may additionally include one or a combination of processing subsystems 318, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, vocoder, messaging, graphics, USB, multimedia, etc. For the disclosed aspects, processing subsystems 318 of processor 306 may include any subsystem components that interact with applications executing on computer platform 302 that enable the functionality described herein. For example, processing subsystems 318 may include any subsystem components that receive data reads and data writes from API 316 on behalf of content selector 320.

Further, communications module 314 may be embodied in hardware, firmware, software, data, executable instructions and combinations thereof, and is operable to enable communications among the various components of wireless device 300, as well as between wireless device 104 and first network 110 and/or second network 116. For example, in cellular telephone aspects, communication module 314 may include the requisite hardware, firmware, software, data, executable instructions and combinations thereof, including transmit and receive chain components for establishing a wireless communication connection.

Further, for example, communication module 314 is operable to receive the plurality of content 102 and the associated respective one or more content metadata 112, if any, from distribution system 108 and forward them to content selector 320 or provide content selector 320 with access to them. Similarly, for example, communication module 314 is operable to receive the one or more selection parameters 122 and either forward them to content selector 320 or provide content selector 320 with access to them. Subsequently, for example, communications module 314 is operable to forward the selected content 126, respectively, to other device components for further processing.

Additionally, one or more input devices 310 for generating inputs into wireless device, and one or more output devices 312 for generating information for consumption by the user of the wireless device are provided. For example, input device 310 may include a mechanism such as a key or keyboard, a navigation mechanism, a mouse, a touch-screen display, a microphone in association with a voice recognition module, etc. In certain aspects, input device 310 provides an interface for receiving user input, such as to activate or interact with an application or module on the wireless device. Further, for example, output device 312 may include a display, an audio speaker, a haptic feedback mechanism, etc. Further, user interface 308 may comprise one or any combination of input devices 310 and/or output devices 312.

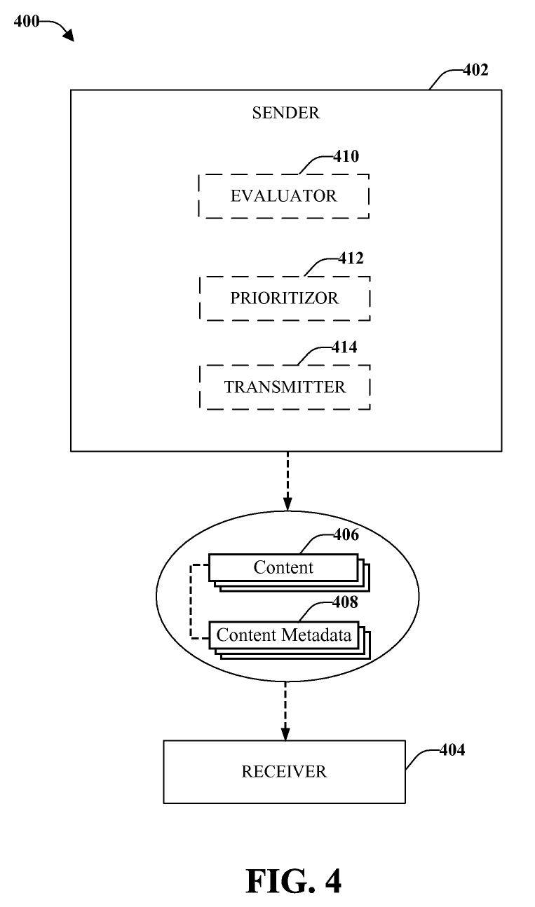

With reference now to FIG. 4, illustrated is a block diagram of an example system 400 for providing content over a digital broadcast network. System 400 can provide a different repetition rate for different data contained with the broadcast. The repetition rate can be based on the importance of the data to a user or based on a preferred order that the data is used by the respective application. For example, an initial experience can be repeated more often than information that is deeper inside an application, which might be obtained if the user proceeds a few screens into the application. The repetition rate takes into consideration the fact that the user might tune into a data broadcast at any time. Thus, the first impression data is repeated more frequently to provide greater responsiveness when switching between applications.

In further detail, system 400 includes a sender 402 (similar to distribution system 108 of FIG. 1) and a receiver 404 (similar to device 104 of FIG. 1). Although one sender 402 and one receiver 404 are illustrated, it should be understood that more than one of each can be included in system 400. Sender 402 can be configured to broadcast content 406 (e.g. data stream) and associated content metadata 408, if any, to receiver 404. The metadata can be applied or associated with the content data by sender 402. Sender 402 can be further configured to evaluate the content 406 and divide the content 406 into at least two subsets and broadcast at least one subset of the content at a different repetition rate than the other subset within the same data stream.

Sender 402 includes an evaluator 410 that can be configured to analyze the information that is to be communicated to receiver. Based on the analysis, evaluator 410 can divide the information into two or more subsets of data. The analysis can take into consideration the order in which the data is presented to the user and/or based on the characteristics of a client side rendering application. For example, a first set of data might be an introduction or other information that a user should perceive in order to select related information. Although the data can be perceived by the user through any means (e.g., audibly, visually) it is easy to think of a first set of data that should be presented as a “first screen.” In order to access information that is linked to the “first screen,” such as contact information, product information, historical information, and so forth, the user should perceive the “first screen” and make selections from that screen (e.g., proceed into lower levels).

A prioritizer 412 can be configured to review a client application and determine when data will be consumed (e.g., at what point during the application). Based on the determination each subset of data can be assigned a weight or priority. The weight or priority can be a function of the importance of a subset of data as compared to the other subsets of data. In accordance with some aspects, the weight is assigned based on the order in which each data is rendered on a user device. It is not necessary that the weight or priority be related to numerical representations, although they may be. The weight or priority could be a numbered sequence or a range that is generated by a hash function. The weight or priority can be numerical-based or based on other criteria, provided there is a system, method or other means for determining the weight or priority of one set of data in comparison to other sets of data.

The weight or priority assigned to each set of data can be utilized to determine a transmission frequency, which can be a function of the relative weight or priority of each set of data as compared to the other sets of data. For example, a set of data assigned a higher priority by prioritizer 412 can be repeated more frequently within the broadcast than a set of data given a lower priority.

A transmitter 414 can selectively transmit the sets of data within the broadcast based on the determined repetition frequency. The data should be transmitted by reference to the preferred order so that receiver 404 displays the data in a proper format, which increases a user experience. The transmitter 414 can send a first set of data at more frequent intervals that at least a second set of data as a function of the characteristics of a client side rendering device. For example, information “A” is primary “first screen” data, information “B” is secondary data, and information “C” is tertiary data (e.g., not necessarily timely). In a typical first-to-last broadcast method, the data would be delivered in the order of A-B-C. This data delivery format can create a delay if the user launches the application during the broadcast of “B”, as the client must receive “C” before receiving “A”. If “A” is the most relevant data, the user-experience is harmed. Thus, transmitter 802 can be configured to delivery the data as “A-B-A-C” in order to deliver the more timely “first screen” data more frequently. This makes the stream loop longer but can provide a better user experience since the delay is for a small number of layers (in this example one layer) in order for the user to receive the more important information. It should be understood that the examples presented herein are simplified and do not describe all possible distribution methods.

In another example, there might be a stock information, quote, or a ticker application where current prices are communicated to receiver 404. Also communicated may be historical information, a raw table of data that lists all the companies, as well as other information (e.g., which companies have been added, which have been dropped). A user, through interaction with receiver 404, might expect to perceive certain information on a first screen (e.g., current price information). If the user desires to view other information (e.g., historical data, raw table, and so forth), the user would proceed to a next screen, such as through a selection for that screen, by pressing a next button, and so on. If the information is being sent in a first-to-last stream, the receiver 404 might obtain the information at any point within the stream, which might not deliver the information the user expects to perceive in a first screen in a timely manner.

To mitigate delays in presentation of data, evaluator 410 can evaluate the stock information 400 and divide the information into subsets, wherein a first subset can be the current information, a second subset can be historical information, and a third subset can be raw table data. Prioritizer 412 can assign a higher weight to the first subset, since the current information is the most relevant to most users. The weight assigned to the second and third subset can be the same weight or a different weight, based on the importance to the user and/or based on standards established by prioritizer 412. A frequency repetition of each subset of data can be a function of the respective assigned weights. For example, the first subset of information can be repeated after both the second subset and the third subset. Therefore, transmitter 416 will send the first subset, then the second subset, then the first subset, then the third subset, then the first subset, then the second subset, then the first subset, and so forth. This repetition frequency allows the first subset to be repeated in the stream of information more often then either the second or the third subset, which enhances a user experience.

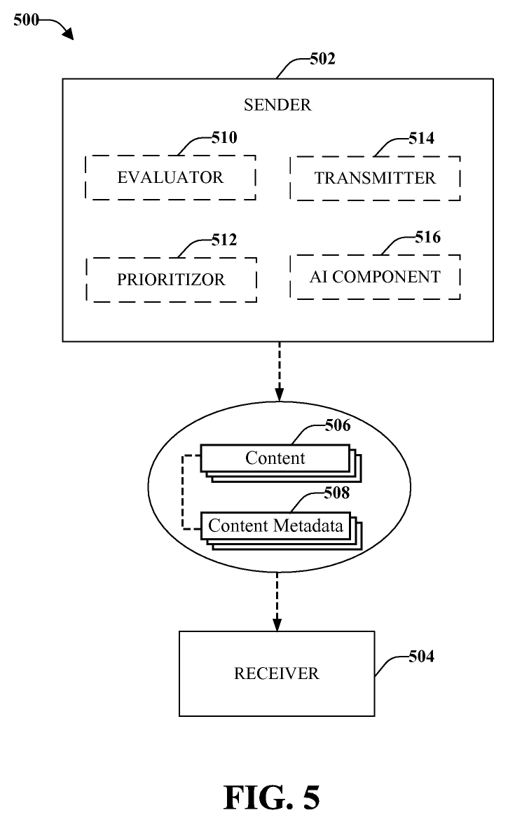

FIG. 5 illustrates an example system 500 that utilizes artificial intelligence to automate one or more aspects. Information should be presented to a user, through respective user device, in the most relevant and efficient manner possible. For example, information should be presented so that the most important data is populated and ready for consumption at substantially the same time as the information is requested. If this information is not available in a timely manner, the user might lose interest and discontinue use of the application.

In further detail, system 500 employs artificial intelligence (AI), which can be facilitated by AI component 516 as illustrated. The various embodiments (e.g., in connection with selectively dividing content into subsets, assigning weights or priorities to these subsets, and determining a repetition frequency based on the assigned weights/priorities) can employ various AI-based schemes (e.g., machine learning and reasoning, rules-based techniques) for carrying out various aspects thereof. For example, a process for determining if a particular subset should be given a higher weight or priority can be facilitated through an automatic classifier system and process. For example, based on a user state AI component 516 can infer the subsets that should be provided more frequently based on an inference of what subsets a user would desire to receive before other subsets.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of assigning subset weights or priorities, for example, attributes can be information included with a particular subset (e.g., importance, relevance to user), and the classes are categories or areas of interest (e.g. user preferences, “first screen” information, and so forth).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria, which streams to render on a device, which streams would be of interest to a user of the device, etc. The criteria can include, but is not limited to, the type of data included in each subset, the content included in each subset, device information, user preferences, and so forth.

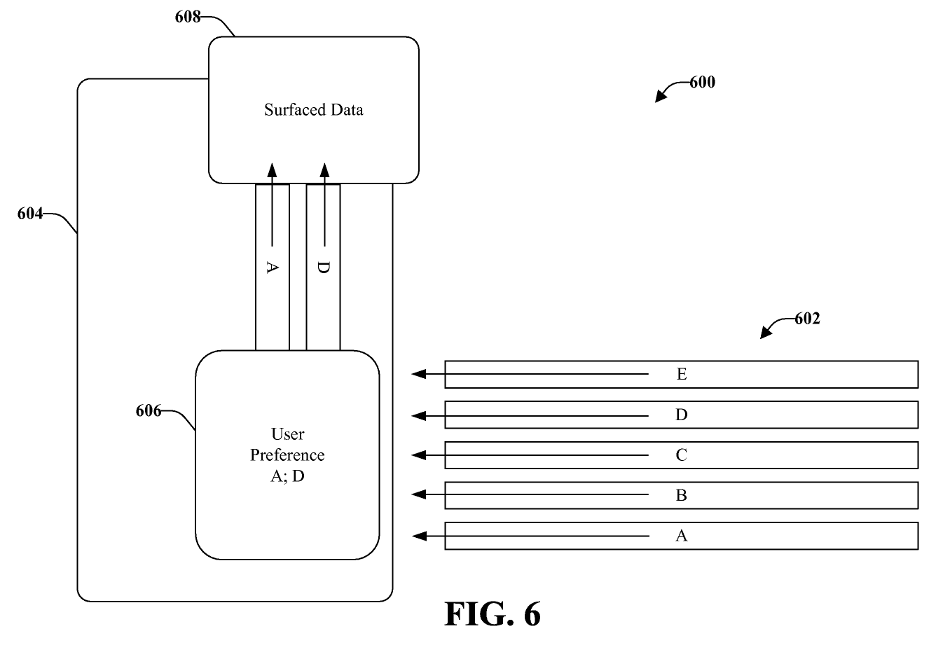

In view of the exemplary systems shown and described above, methodologies that may be implemented in accordance with the disclosed subject matter, will be better appreciated with reference to the flow charts of FIGS. 6-8. While, for purposes of simplicity of explanation, the methodologies are shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 illustrates a system 600 that delivers an experience of timely data of a category and type of particular interest to a user. System 600 can be configured to utilize the constant uptime and unique distribution platform of a MediaFLO multicasting wireless network, for example. This exemplary system 600 allows a user to set preferences for data, which such user is interested in receiving. The information concerning the user preferences can be surfaced automatically for easy access.

One or more data streams 602 (labeled “A”, “B”, “C”, “D”, and “E”) can be transmitted to a user device 604. Each stream can be updated in a real-time manner such that changes to the data included in each stream are received at the device 604 at substantially the same time as the changes are applied. As the data streams are received, each stream is compared to a preference selection 606. This preference selection 606 can be configured by a user through a user interface or other means. The preference selection 606 can include a category associated with one or more data streams, a type of one or more data streams, or combinations thereof. As the transmitted data streams 602 are compared to the preference selections 606, one or more streams are received, combined and automatically presented to the user, such as through a display 608.

In an example, sports data is being provided and MediaFLO, for example, can deliver timely data of every major sport in the United States and international sports as the events occur. This delivery of data is illustrated by data streams 602. Timely delivery of this data allows the user to receive updates on every sport currently being played. The user is provided the ability, such as through a user interface 604, to drill into or select specific games of interest based on the updates received. In accordance with some aspects, the user is updated on all the data included as a preference, up to and including all available data for which the embodiment applies. Thus, if the user selects data streams “A” and “D”, these streams are combined and automatically surfaced though display 606.

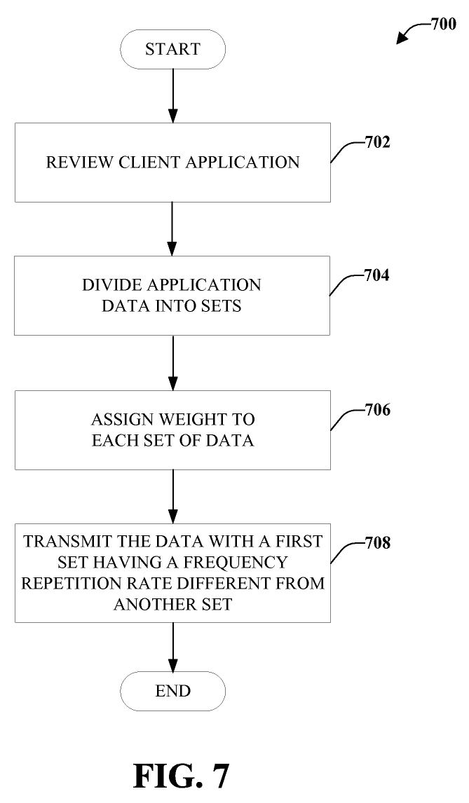

FIG. 7 illustrates a method 700 for providing content. Data should be delivered in such a manner that a user receives data that should be consumed first at substantially the same time as requesting the data while mitigating delays associated with rendering the data. Method 700 can facilitate transmitting information such that a first set of data (e.g., the data to be consumed first) is repeated more frequently than a second set of data (e.g., data that will be consumed after the first set of data) within the transmission. The repetition frequency is a function of the characteristics of a client side rendering device.

In order to facilitate transmission of data that can improve a user experience, method 700 begins, at 702, when a client application is reviewed. The client application is reviewed to determine how the information will be consumed on a user device. This review can take into consideration which portions of the information should be rendered on a user device first, such as “first screen” data, and which information can be provided in a less timely manner (e.g., secondary data). The application can be reviewed to determine which should be a first screen or other first perceivable information that should be presented to the user. For example, a first screen might be a home page that facilitates selections of one or more screens that can be accessed through the home page. Another example can be current weather conditions or current/breaking news stories. Other factors to be considered are the data that would be most important to, or most relevant for, the user, the ease of use of the application, and so forth.

Based on the determination, the application data can be divided into two or more sets of data, at 704. A first set of data can contain information that should be consumed first by the application. One or more other sets of data can contain information that is consumed after the first set of data (e.g. lower-level screens). Application data can be divided into any number of sets of data.

A weight or priority can be assigned to each set of data, at 706. The weight can be assigned to each set of data based on when each set of data will be consumed by the client application, which can be determined based on a sequence or order that each data set will be rendered on a user device. The weight can also be assigned by comparing an importance level of each set of data as compared to the other sets of data, the weight is used to determine the frequency interval. The weight can be an indication of a repetition frequency or rate at which each set of data should be transmitted in a single transmission. For example, an application can be divided into three sets of data, “A”, “B”, and “C.” A weight of 1 can be assigned to set “A” and set “C” and a weight of 2 can be assigned to set “B.”

At 708, a stream that includes the sets of data is transmitted. At least one set of data repeats more often (e.g., repetition frequency) than at least a second set of data. Based on the above example and the respective weights, the data can be transmitted as “A”-“B”-“C”-“B”-“A”-“B”-“C” and so forth. A receiving device can render the appropriate data more quickly based on the repetition rate of the data included within the transmission, which can enhance a user experience.

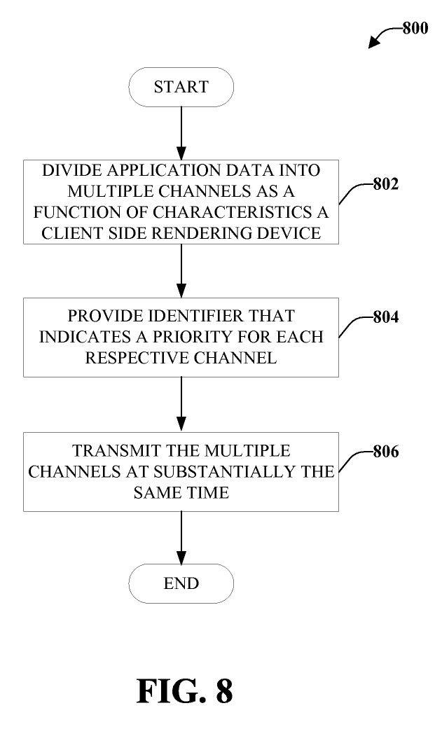

FIG. 8 illustrates a method 800 for transmitting a multitude of channels as a function of a client-side rendering experience. Application data can be divided into multiple channels based on how the respective application consumes data.

At 802, an application is divided into multiple streams as a function of characteristics of a client side rendering device. Dividing the application can take into consideration how the application will be presented to a user. The information that is to be presented first, such as a “first screen”, can be a first stream; information that is to be presented second, such as a screen that is accessed from the first screen, can be a second stream; and information that is to be presented third, can be a third stream.

Each stream can be given a priority based on the order that it will be presented to the user. An identifier can be included with each stream, at 804, that indicates the relative priority (or weight) given to each individual stream. The priority (or weight) can be used by rendering device to determine which streams, if any, to accept the data.

At 806, the multiple streams are transmitted at substantially the same time so that a rendering device can identify and accept appropriate streams. In accordance with some aspects, the transmission of certain streams is shifted slightly to account for a transmission delay in one type of stream over another type of stream.

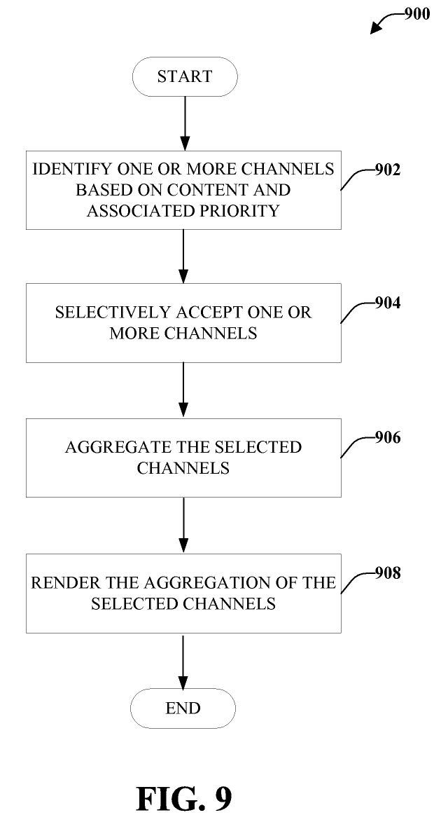

FIG. 9 illustrates a method 900 for selectively accepting one or more channels as a function of characteristics of a rendering device. The rendering device can selectively accept one or more channels based on selection parameters and/or a weight or priority assigned to each channel. In accordance with some aspects, the rendering device can comprise a multitude of display templates, each template can be associated with one or more unique data streams to efficiently render those data streams in a particular sequence.

Method 900 starts, at 902, when one or more channels are identified based on content and associated priority. The priority can be assigned by a transmitting device and can indicate a preferred order that the channels should be accepted at receiving device in order to enhance a user experience. The content and priority identification can be included in the channel as metadata or other data associated with the channel.

Based on the content and priority identification, one or more channels can be selectively accepted, at 904, by receiving device. The selection might be based on selection parameters and may include, for example, data such as one or more content filters (e.g., relevant information contained in a stream, priority data), one or more data representing user information (e.g., preferences), and/or one or more data representing device information (e.g., capabilities, limitations, display size, audio functionality).

At 906, the one or more selected channels are aggregated in order to provide a unique user experience. It should be understood that receiving device might only accept one channel, and thus, the information and rendering experience provided by that channel would be presented to the user in any perceivable means (e.g., visually, audibly). As each channel is selected or aggregated, a respective display template associated with that channel is populated with the information contained in the channel.

The accepted channel or channels are presented to the user, at 908. Such rendering can be facilitated based on the priority or weight assigned to each channel. In such a manner a unique user experience can be provided that intelligently manages the data in order to provide a more robust user experience.

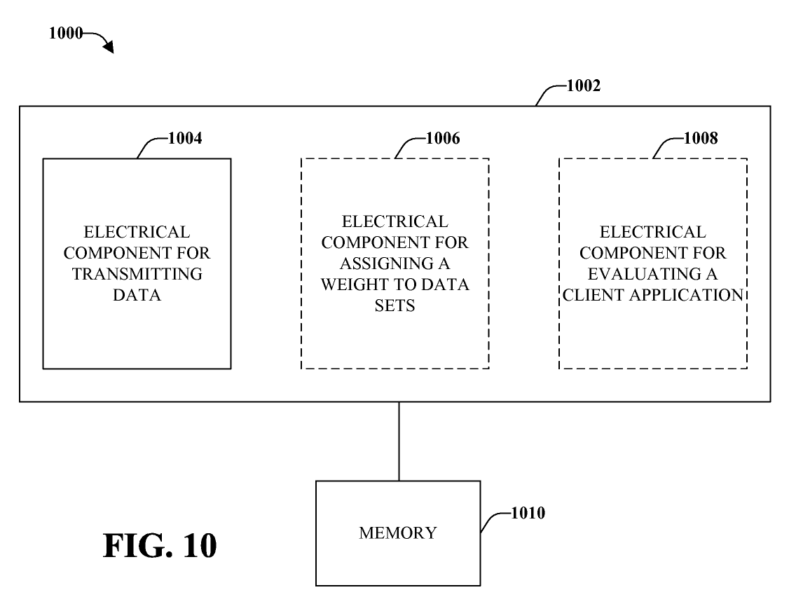

With reference to FIG. 10, illustrated is an example system 1000 for selectively transmitting a first data set more frequently than at least a second data set. For example, system 1000 may reside at least partially within a sending device. It is to be appreciated that system 1000 is represented as including functional blocks, which may be functional blocks that represent functions implemented by a processor, software, or combination thereof (e.g., firmware).

System 1000 includes a logical grouping 1002 of electrical components that can act separately or in conjunction. For instance, logical grouping 1002 may include an electrical component for transmitting information 1004. The information can be transmitted such that a first data set is repeated more frequently than at least a second data set within the transmission. The frequency repetition can be a function of the characteristics of a client side application rendering the data set on a user device.

Additionally or alternatively, logical grouping 1002 can include an electrical component for assigning a weight to each data set 1006. The weight can be assigned by comparing an importance level of each data set as compared to the other sets of data. The weight can be used to determine the frequency interval.

In accordance with some aspects, logical grouping includes an electrical component for evaluating a client application 1008. The electrical component 1008 can further divide the client application into a first data set and at least a second data set. The electrical component for assigning a weight to each data set 1006 can assign the weight based on when each data set will be consumed by the client application. The frequency repetition can be a function of the assigned weight.

Additionally, system 1000 can include a memory 1010 that retains instructions for executing functions associated with electrical components 1004, 1006, and 1008 or other components. While shown as being external to memory 1010, it is to be understood that one or more of electrical components 1004, 1006, and 1008 may exist within memory 1010.

It is to be understood that the embodiments described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within scope of the appended claims. To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description of the claims is meant to be a “non-exclusive or.”

What is claimed is:

1. A method for transmitting content, comprising:
transmitting information such that a first set of data is repeated more frequently than at least a second set of data within the transmission, wherein the frequency of repetition is a function of the characteristics of a client side application that is rendering the data.

2. The method of claim 1, further comprising assigning a weight to each set of data by comparing an importance level of each set of data with the other sets of data, the weight is used to determine the frequency of repetition.

3. The method of claim 1, further comprising:
reviewing a client application;
dividing the client application data that is consumed by the client application into a first set of data and at least a second set of data; and
assigning a weight to each set of data based on when each set of data will be consumed by the client application.

4. The method of claim 3, reviewing the client application comprises determining how received data will be consumed by the client application when executed on a user device.

5. A device for transmitting content, comprising:
a computer platform having a memory and a processor wherein the memory stores information related to decisions made by the processor;
an evaluator that analyzes information within a data stream;
a prioritizer that reviews a client application and determines when data sets within the data stream will be consumed by the client application; and
a transmitter that selectively transmits the data sets at different repetition rates within the data stream with reference to when the data sets will be consumed by the client application.

6. The device of claim 5, the transmitter sends a first data set at more frequent intervals that at least a second data set with reference to when each data set will be consumed by the client application.

7. The device of claim 5, the prioritizer further assigns a weight to each set of data as a function of comparing the sets of data, the weight is used to determine the frequency interval.

8. An apparatus for selectively transmitting a first data set more frequently than at least a second data set, comprising:
means for transmitting information such that a first data set is repeated more frequently than at least a second data set within the transmission, wherein the frequency repetition is a function of the characteristics of a client side application rendering the data set on a user device.

9. The apparatus of claim 8, further comprising a means for assigning a weight to each data set by comparing an importance level of each data set as compared to the other sets of data, the weight is used to determine the frequency interval.

10. The apparatus of claim 8, further comprising:
means for evaluating a client application and dividing the client application into a first data set and at least a second data set; and
means for assigning a weight to each data set based on when each data set will be consumed by the client application.

11. The apparatus of claim 10, the frequency repetition is a function of the assigned weight.

12. A machine-readable medium having stored thereon machine-executable instructions for:
reviewing a client application;
dividing the client application data that is consumed by the client application into a first set of data and at least a second set of data;
assigning a weight to each set of data based on when each set of data will be consumed by the client application; and
transmitting the client application such that a first set of data is repeated more frequently than at least a second set of data with the transmission, wherein the frequency repetition is a function of the characteristics of a client side rendering device.

13. The machine-readable medium of claim 12, the instructions further comprises assigning a weight to each set of data by comparing an importance level of each set of data in comparison to the other sets of data, the weight is used to determine the frequency interval.

14. A system for delivery of timely data, comprising:
a user interface that receives a preference selection for at least one data stream; and
a display that automatically presents the at least one data stream based on the preference selection.

15. The system of claim 14, the preference selection includes a selection for a category, a type, or combinations thereof.

16. The system of claim 14, wherein the at least one data stream is received at substantially the same time as the at least one data stream is updated.
